(19) United States
(12) Patent Application Publication
(10) Pub. No.: US 2015/0252958 A1
(43) Pub. Date: Sep. 10, 2015

(54) Edge-Lit LED Retrofit for a Fluorescent Tube

(71) Applicant: Lunera Lighting, Inc., Anaheim, CA (US)

(72) Inventors: Don Barnetson, San Jose, CA (US); Daryl Cheim, San Jose, CA (US); Junyun Wang, Palo Alto, CA (US); George Xie, San Jose, CA (US)

(73) Assignee: Lunera Lighting, Inc., Anaheim, CA (US)

(21) Appl. No.: 14/201,428

(22) Filed: Mar. 7, 2014

(51) Int. Cl. F21K 99/00; F21V 29/503; F21V 23/00; F21V 23/02; F21V 8/00; F21V 29/70

(52) U.S. Cl. CPC F21K 9/17; F21K 9/52; G02B 6/001; F21V 29/70; F21V 23/008; F21V 23/02; F21V 29/503

(57) ABSTRACT

An edge lit LED tube that can control light compatible with different ballast such as instant start, rapid start and programmed start is provided. The edge lit LED tube can tune the output light angle by controlling the etching of the acrylic light guide. An edge lit LED tube that has no minimum LED count and can be driven from a single LED is further provided.

### FIELD OF THE INVENTION

The present invention relates to a retrofit LED lighting system, and more particularly to an edge-lit LED retrofit lighting system for a fluorescent tube.

### BACKGROUND

A variety of LED retrofit light tubes exist in the prior art, these light tubes have the drawbacks of having a relatively narrow illumination angle and uneven light distribution. A diffuser is provided on top of the housing of the light tubes above the LEDs, the light emitted by the LEDs is diffused around the diffusion areas on the top. As a result, the illumination angle of the light tubes is still small, and a large part of the tube cannot emit light and forms a dark area.

Therefore, there is a need for a LED light tube that cost-effectively provides uniform illumination along the tube with an illumination angle of 180 degrees or above to cater to various illumination applications. There is also a need for a LED light tube that increases luminous efficiency and has a reduced loss of light energy.

### BRIEF SUMMARY OF THE INVENTION

An aspect of the present invention provides a LED retrofit tube that provides a replacement for a fluorescent tube. The retrofit tube is a LED tube that is based on edge-lit technology and is compatible with all known ballast types such as instant start, rapid start and programmed start ballast. The retrofit tube consists of a circuit that converts the AC waveform generated by the ballast into the DC waveform suitable for the LEDs.

The retrofit tube comprises a set of end caps that are placed at both the ends of the tube, each end cap has a PCB circuit at one side and has two pins on the other side for establishing electric connection with the socket; a set of hollow cylindrical heat sinks attached to each end cap for dissipating heat generated by the LEDs; a MCPCB plate mounted with a LED; a hollow or solid cylindrical light guide that guides the light generated from the LED mounted on the MCPCB plate to the other end. The emission angle in the retrofit tube is controlled by controlling the etching of the surface of the light guide. The PCB circuit is comprised of a bridge rectifier having schottky diodes, and a large capacitor that is placed in parallel to the bridge rectifier. The retrofit tube is compatible with the existing fluorescent ballast and hence does not require the removal of fluorescent ballast while replacing the fluorescent tube with the LED tube.

### BRIEF DESCRIPTION OF THE DRAWINGS

The preferred embodiments of the invention will hereinafter be described in conjunction with the appended drawings provided to illustrate and not to limit the scope of the invention, wherein like designation denote like element and in which:

FIG. 1 illustrates a direct lit LED retrofit tube.

FIG. 2 illustrates an edge-lit LED retrofit tube in accordance with an embodiment of the present invention.

FIG. 3 illustrates an exploded view of the edge-lit retrofit LED tube in accordance with an embodiment of the present invention.

FIGS. 4A and 4B illustrate a light guide for controlling emission angle of the light output in accordance with an embodiment of the present invention.

FIG. 5 illustrates a schematic representation of a PCB circuit for the edge-lit LED lamp driven by a ballast, in accordance with an embodiment of the present invention.

### DETAILED DESCRIPTION OF THE EMBODIMENTS

In the following detailed description of the embodiments of the invention, numerous specific details are set forth in order to provide a thorough understanding of the embodiments of the invention. However, it will be obvious to a person skilled in art that the embodiments of the invention may be practiced with or without these specific details. In other instances well known methods, procedures and components have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

An LED retrofit tube that provides a replacement for a fluorescent tube driven by a ballast is further described herein. The characteristic of the LED retrofit tube over the conventional LED tube is that the retrofit tube of the present invention is based on the edge-lit technology. The LED mounted on the MCPCB plate is placed at the edge of the tube. The light emitted from the LED is passed through a light guide, a solid or hollow tubular structure that uses an internal reflection mechanism for guiding the light through the whole tube. The use of edge-lit technology enables the tube to be lit even by a single LED. The conventional LED tube based on direct lit technology must have a minimum LED count in the range of hundreds, so as to avoid pixilation on the lens. The light guide is made of optical grade materials such as acrylic resin, polycarbonate, epoxies and glass. In an aspect of the present invention, the light guide can be a U-shape or a circular, a cylindrical, a helical or a cubical structure.

In an aspect of the present invention the retrofit tube is designed to enable light output tuning to suit the user's requirement. The emission angle of the retrofit LED tube is controlled by controlling the etching of the light guide. The etching of the surface of the light guide enables the light to escape from the etched area. The surface can be etched so as to make the emission angle from as little at 90° or as much as 360° with different designs.

The circuit of the retrofit LED tube is comprised of a bridge rectifier that is used to convert the AC waveform of the fluorescent ballast to a single sided waveform, and a capacitor to filter the waveform to generate DC output to LED. The ballast can be an electronic ballast or an electromagnetic ballast.

The circuit may comprises a resistor placed in series with the input port, an inductor placed in series with the cathode input, a bridge rectifier that converts the AC waveform coming from the ballast to DC waveform, a capacitor placed in parallel to the bridge rectifier and the LED.

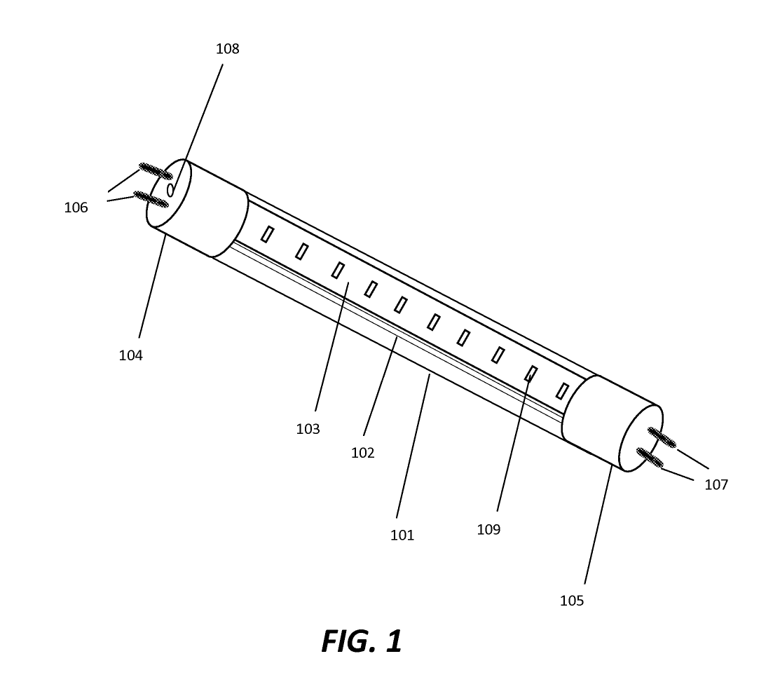

FIG. 1 illustrates a direct lit LED retrofit tube that exists in the prior art. The direct lit LED retrofit tube consists of a tubular housing 101 having a plurality of LEDs, a PCB 109 comprising the electric circuit is placed in the tubular housing 101, a reflector 103 is provided on the top of the tubular housing 101, a front cover 102 made of optically transparent material and a pair of side covers 104 and 105 having two pins 106 and 107 are provided for establishing connection with the main supply. The reflector 103 is used to control the emission angle of the LED light. A plurality of slits is provided in the reflector 103; the slits provide an opening for the LEDs. The reflector 103 reflects the light so that the emission angle of the light is controlled. The LED retrofit tube as described earlier is direct lit as the light is exposed directly in the area without any internal reflection mechanism. The direct lit retrofit LED lamp requires a minimum number of LEDs to avoid pixilation on the lens. The minimum number of LEDs that is required in direct-lit LED tube of 48 inches size must be at least one hundred, so that there will be sufficient output by the LED tube. This increases the manufacturing cost of a LED tube.

The front cover 102 is a circular tubular structure made of an elastic transparent material (such as a plastic material) that is an electrical insulator capable of avoiding electric shocks and a heat dissipating opening 108 is formed axially along the tubular housing 101. The plurality of LEDs is arranged on a panel that is mounted on the tubular housing 101. The pair of side covers 104 and 105 are made of an insulating material and respectively sheathed on both end portions of the transparent cover 101, wherein the side covers 104 and 105 contain the pair of electrical connection portions 106 and 107, and the electrical connection portions 106 and 107 are electrically coupled to the pair of side covers 104 and 105. In addition, each of the side covers 104 and 105 has a fixing hole formed at a position for installing and securing an insulating screw, and a nut portion of the insulating screw is made of an insulating material, so that after the side covers 104 and 105 are secured to both end portions of the front cover 101 or the side covers 104 and 105 are fixed directly to both end portions of the tubular housing 101 by an adhesive, a complete insulation effect can be achieved to prevent a possible electric shock that may occur when a user changes the fluorescent tube.

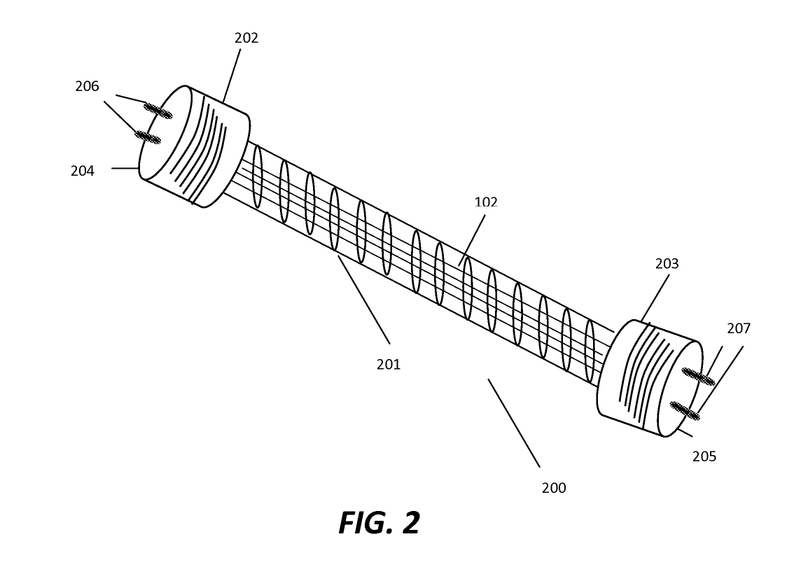

FIG. 2 illustrates an edge-lit LED retrofit fluorescent tube in accordance with an embodiment of the present invention. While this invention is illustrated and described in preferred embodiments, the edge-lit LED retrofit fluorescent tube may be produced in many different configurations, sizes, forms and materials. Referring to FIG. 2, the edge-lit LED retrofit fluorescent tube 200 is constructed consistent with a preferred embodiment of the present invention. The LED retrofit fluorescent tube 200 is sized in length and diameter for replacing conventional fluorescent light tube in a fluorescent fixture. The LED retrofit tube can be produced to replace the fluorescent tube that is available in T2, T3, T4, T5, T8, T12 sizes. In an embodiment, the edge-lit LED retrofit fluorescent tube 200 comprises a light guide 201, a first heat sinks 202 and a second heat sink 203, a LED 303 mounted on a MCPCB plate 302, and a first end cap 204 and a second end cap 205. The edge-lit LED retrofit fluorescent tube 200 further comprises a PCB circuit 301 for controlling the LEDs 303. The PCB circuit 301 is mounted on the inner side of the first end cap 204 of the edge-lit LED retrofit fluorescent lamp 200. The first heat sink 202 is placed between the first end cap 204 and the circular end of the light guide 201. Similarly the second heat sink 203 is place between the second end cap 205 and the other end of the light guide 201. The first heat sink 202 and the second heat sink 203 are present at opposite ends of the edge-lit LED retrofit fluorescent tube. The light guide 201 is tubular or cylindrical in shape and has a circular end that fits into the circular end of the first heat sink 202 and the second heat sink 203. The light guide 201 is made of material selected from optical grade materials such as acrylic resin, polycarbonate, epoxies and glass.

In an aspect of the present invention, the light guide can be a circular, cylindrical, helical or U-shaped.

In an embodiment of the invention, the LED 303 is mounted on a MCPCB plate 302 and is placed in between the first heat sink 202 and the light guide 201. The LED 303 is connected to the PCB circuit 301 placed in the inner housing on the first end cap 204. The one terminal PCB circuit 301 is electrically connected to the input pins on the first end cap 204 and the second terminal of PCB circuit 301 is connected to the input pins on the second end cap 205 through a wire that spans across the tube in the middle of the light guide 201. The MCPCB 302 is mounted perpendicular to the axis of the edge-lit LED retrofit fluorescent tube 200 such that the light emitted by the LED 303 strikes on the lateral walls of the light guide 201. The light guide 201 uses the phenomenon of internal reflection and the edge-lit technology propagates the light emitted by the LED 303 through the edge-lit LED retrofit fluorescent tube 200.

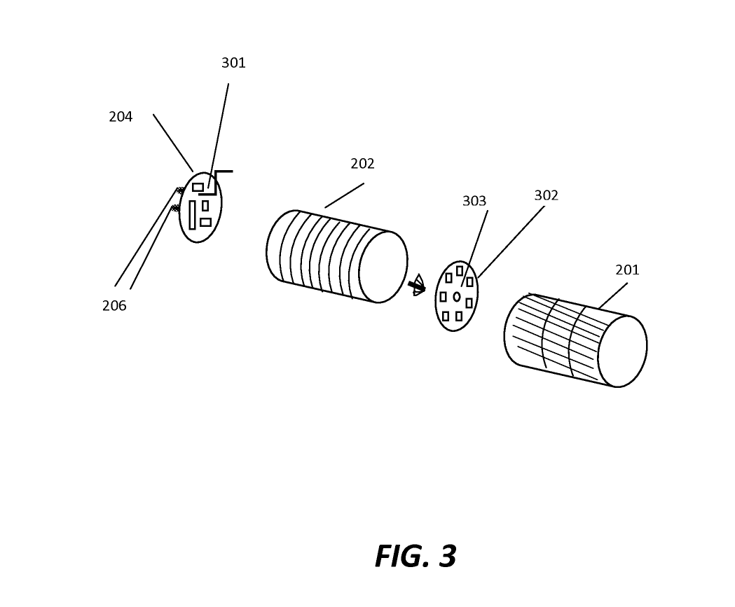

In an aspect of the present invention, the first heat sink 202 and the second heat sink 203 are present at both ends of the light guide 201, thus enabling maximum heat dissipation. The arrangement of the first heat sink 202, second heat sink 203 and the PCB circuit 301 not only prevents the PCB circuit 301 from subjecting to the high temperature due to the heat generated by the LED 303, but also ensures that the light emission of the LED 303 through the tube would not be hindered by the PCB circuit 301. The first heat sink 202 and the second heat sink 203 are configured to couple to the light guide 201 in a manner that the openings on the both end of the light guide 201 are completely covered resulting in a tubular structure. As illustrated in FIG. 2 and FIG. 3, the first heat sink 202 and the second heat sink are fixed to both opposite ends of the light guide 201.

The heat sink is preferably fabricated from a thermally conductive material selected from the group consisting of metals such as aluminum and aluminum alloy, plastics and ceramic. The material of the pair of heat sink preferably has a high mechanical strength, so that the tubular structure formed by coupling the pair of first heat sink 202, the second heat sink 203 and the light guide 201 together remains rigid in the required length.

In another aspect of the present invention, the edge-lit LED retrofit fluorescent tube may comprise a LED 303 mounted on the MCPCB plate 302. As the number of LEDs increase, the luminous intensity of the tube increases. However, in a preferred embodiment the number of LED mounted on MCPCB 302 is one.

In another aspect of the present invention, the light guide is etched to control the emission angle of the light. The etching is done to suit the lumen output requirement, for instance, if it is desired that the light emitted is to be spread at an angle of 180°, then the half of the light guide surface is etched, the light escapes from the etched surface of the light guide while un-etched surface restricts the light to escape from the tube. The surface of the light guide can be etched so as to allow the emission angle from as low as 90° to as high as 360°.

FIG. 3 illustrates an exploded view of the edge-lit LED retrofit fluorescent tube in accordance with an embodiment of the present invention. The edge-lit LED retrofit fluorescent tube 200 comprises a first end cap 204 and a second end cap 205 present at both the ends of the edge-lit LED tube 200, the first end cap 204 has a housing for a PCB circuit 301; a first heat sink 202 and a second heat sink 203 is attached to the first end cap 204 and the second end cap 205 respectively; a MCPCB plate 302 is mounted with a LED 303; a hollow or solid cylindrical light guide 201 is provided that guides the light generated from the LED 303 mounted on the MCPCB plate 302 to the other end. The end caps are made of electrically insulating material such as resin polycarbonate. On the terminal end of the end caps, there are provided a plurality of switch input connector, i.e. two switch input connectors 206 and 207 are provided on one side of the first end cap 204 and the second end cap 205. The switch input connectors 206 and 207 are made of material such as copper that provide connectivity to the main AC supply coming from the ballast. The inner side of the first end caps 204 contains a housing for the PCB circuit 301. The PCB circuit 301 converts the AC waveform supplied by the fluorescent ballast to the DC waveform required by the LEDs. The housing is made of plastic such as resin polycarbonate.

The MCPCB plate 302 has a LED mounting side on which the LED 303 is mounted and a heat transferring side opposite to the LED-mounting side for dissipating the generated heat through the first heat sink 202. The LED 303 on the MCPCB plate 302 is connected to the PCB circuit 301. The PCB circuit 301 is directly connected to the switch input connector 206 and 207 of the first end cap 204 and through a wire to the switch input connector of the second end cap 205. The wire spans across the light guide 201 passing in the centre of the light guide 201.

The LED light source can be a LED, a LED package or an LED array. The plurality of LEDs may be connected in series and/or in parallel, but they are mounted axially in a single straight line on the MCPCB plate 302. The arrangement of the LED 303 is particularly cost-effective in terms of the capacity of the heat sinks and the light output efficiency of the light tube. For example, the edge-lit LED retrofit fluorescent tube 200 is built with high-luminous efficacy LEDs and produces 2300 lumens at just 20 W, emit less heat (3.4 BTUs per hour versus 30 BTUs) and fit any T8 and T12 fixtures.

The light output of the edge-lit LED retrofit fluorescent tube 200 can obtain an enhanced luminous efficiency, and it has been found that the luminous flux of the edge-lit LED retrofit fluorescent tube 200 is increased with respect to the existing LED light tubes in the prior art for the reasons of improved light emission discussed below, hence low power LEDs can be used in the edge-lit LED retrofit fluorescent tube 200 to provide natural and evenly distributed light pattern. This saves energy and allows for a heat sink of smaller size.

The first end caps 204 and the second end cap 205 is designed to fit over the first heat sinks 202 and the second heat sink 203 respectively. In the embodiment, each end caps includes two pin connectors for connection to the fluorescent light tube socket. The two pin connectors are electrically connected to the socket for providing power to drive the LED 303. With such a wiring arrangement, the edge-lit LED retrofit fluorescent tube 200 can maintain its functionality no matter which direction it is plugged into the fluorescent light tube sockets. The end caps are made of plastic, or metal or a combination thereof.

Assembling the edge-lit LED retrofit fluorescent tube 200, involves electrically attaching the MCPCB 302, securing the MCPCB 302 onto the first heat sink 202 coupling both the ends of the light guide 201 to the first heat sink 202 and the second heat sink 203 and attaching the first end cap 204 to the first heat sink 202 and the second end cap 205 to the second heat sink 203 resulting in a tubular structure. The PCB circuit is connected to the switch input connector of the first end cap 204 directly and to the switch input connector on the second end cap 205 through a wire spanning across the tube through the centre of the light guide.

The thermal conductivity of the material of the heat sinks directly affects the dissipation of heat through conduction. The heat sinks can be made of aluminum or copper or thermoplastic material or a natural graphite solution that offers better thermal transfer than copper with a lower weight than aluminum. The heat sinks are made of natural graphite solution and they have the ability to be formed into complex two dimensional shapes.

In another aspect of the present invention, the edge-lit LED retrofit fluorescent tube can be used to replace existing fluorescent tubes such as T2, T3, T4, T5, T8, T10 or T12 fluorescent tubes. The edge-lit LED retrofit fluorescent tube is compatible with instant start, rapid start, and programmed start ballast. Thus, there is no need for removing the existing ballast structure and thus saves considerable cost by eliminating the need of a skilled person to remove the existing fluorescent tube and the ballast. The edge-lit LED retrofit fluorescent tube 200 has a PCB circuit 301 that comprises a bridge rectifier, and a large capacitor placed in parallel to the bridge rectifier. The bridge rectifier is made of schottky diodes that convert the high frequency alternating current generated by the fluorescent ballast to the direct current required for the working of LEDs.

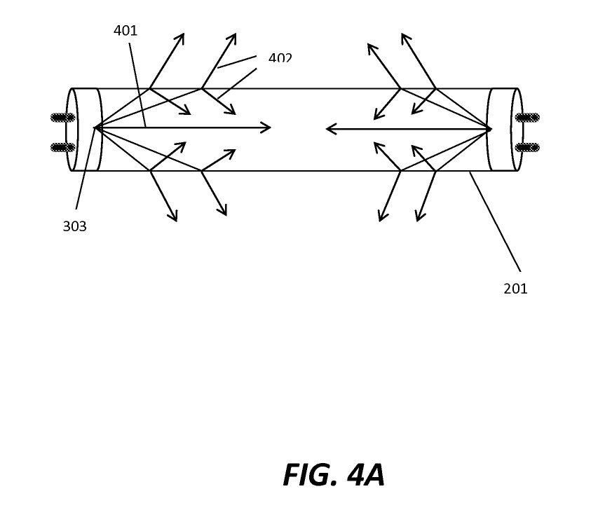

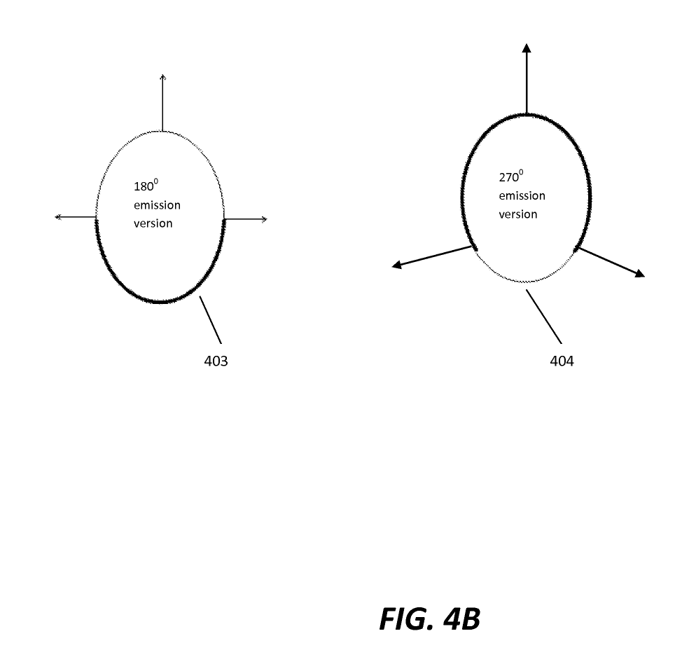

FIGS. 4A and 4B illustrate a light guide for controlling emission angle of the light output in accordance with an embodiment of the present invention. Light emitted by the LED 303 can be directed into the environment from the edge-lit LED retrofit fluorescent tube 200 by a light guide as shown in FIG. 4 A. The edge-lit LED retrofit fluorescent tube 200 can include the LED 303 that emits light lateral to the horizontal axis of the LED tube. Emitted light 401 propagates through light guide positioned adjacent to the LED 103. The inner surface of the light guide 201 is highly reflective, a large portion of the incident light generated by the LED 303 are reflected back to the interior portion of the light guide. The reflected light can exit the light guide 201 from different angles or directions corresponding to the acrylic surface etching as shown in FIG. 4B. The reflected lights 402 can also generate secondary “reflux” reflections on the reflective inner surface of the light guide 201, the pair of heat sinks 202 and 203, and the reflective exposed surface of the PCB circuit 301 to yield a portion of refluxed light that enhances the light output of the edge-lit LED retrofit fluorescent tube 200. The inner surface of the light guide 201 may be constructed to enhance the reflectance and reflux of the light. In FIG. 4B, the acrylic etching of the surface of the light guide 201 is carried out. The etching is done at an angle of 180° as shown by the lumen output 403 and 900 as shown in lumen output 404. The etching on the surface of the light guide facilitates the escape of light from the tubular structure. Thus, by doing the surface etching for 180° as shown in lumen output 403, the emission angle can be controlled to 180°. Similarly three-fourth surface of the light guide can be etched to emit the light at 270° as shown in lumen output 404.

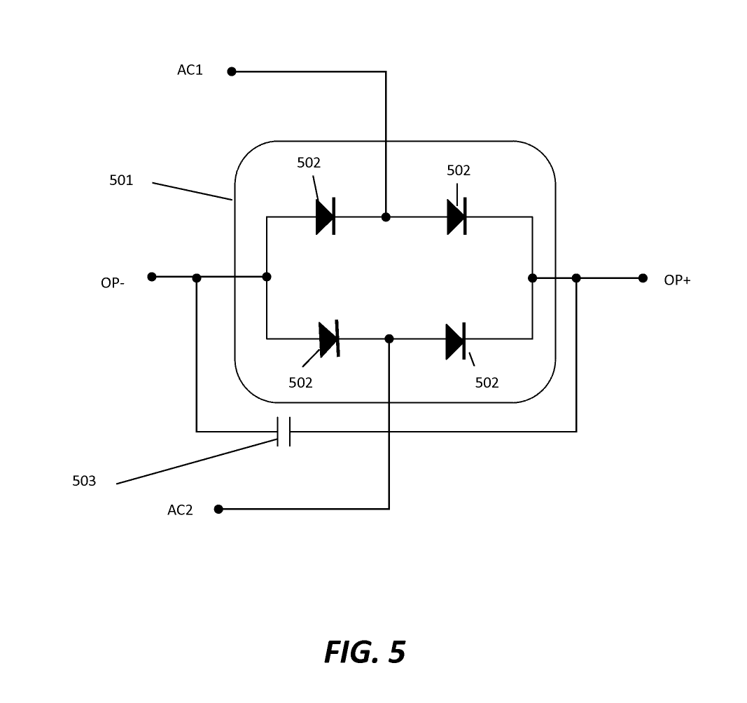

FIG. 5 illustrates a schematic representation of a PCB circuit 301 for the edge-lit LED retrofit fluorescent tube 200 driven by a ballast in accordance with an embodiment of the present invention. Referring to FIG. 5, an output from the electronic or electromagnetic ballast serves as an input to the PCB circuit 301. The input is then fed into a bridge rectifier 501 that converts the AC waveform of the fluorescent ballast to a single sided waveform. The bridge rectifier 501 is made of four diodes 502 arranged in a bridge manner. The diodes 502 used in the bridge rectifier 501 are schottky diodes and not the traditional silicon diode. A capacitor 503 is placed in parallel to the bridge rectifier 501. The capacitor 503 filters the single sided waveform to reduce the ripple current and the output from the circuit is then served as an input to the LED 303.

We claim:

1. An edge-lit LED tube comprising:
a first end cap and a second end cap present at first end and second end of the edge-lit LED tube, the said first and second end caps have two connector pins at one side;
a housing present at the second side of the first end cap to contain a PCB, the said PCB comprises a circuit that provides the waveform required to drive the edge-lit LED tube;
a first heat sink attached to the first end cap and a second heat sink attached to the second end cap, for dissipating the excess heat;
a MCPCB plate mounted with a LED light source that emits the light perpendicular to the axis of the MCPCB plate, the said MCPCB plate is attached to the first heat sink
a light guide connects the MCPCB plate at one end and the second heat sink at the other end forming a rigid structure, wherein the light guide propagate the light through the edge-lit LED tube.

2. The edge-lit LED tube of claim 1 wherein the first heat sink and the second heat sink are made of aluminum or copper or thermoplastic material or a natural graphite solution.

3. The edge-lit tube of claim 1 wherein the LED light source comprises a single LED or a plurality of LEDs.

4. The edge-lit tube of claim 1 wherein the LED light source is placed such that the light emitted by the LED light source is in lateral axis to the edge-lit LED tube.

5. The edge-lit tube of claim 1 wherein the light guide is made of material selected from optical grade material such as acrylic resin, polycarbonate, epoxies and glass.

6. The edge-lit tube of claim 1 wherein the light guide uses internal reflection phenomenon for propagating the light through the edge-lit LED tube.

7. The edge-lit LED tube of claim 1 wherein the LED tube is designed to fit T2, T3, T4, T5, T8, T10 or T12 type sockets.

8. The edge-lit LED tube of claim 1 wherein the edge-lit LED tube is cylindrical, circular, tubular, cubical, helical or U-shape.

9. An edge-lit LED tube comprising:
a first end cap and a second end cap present at first end and second end of the edge-lit LED tube, the said first and second end caps have two connector pins at one side;
a housing present at the second side of the first end cap to contain a PCB, the said PCB comprises a circuit that converts the waveform generated by the ballast to the waveform required to drive the edge-lit LED tube;
a first heat sink attached to the first end cap and a second heat sink attached to the second end cap, for dissipating the excess heat;
a MCPCB plate mounted with a LED light source that emits the light perpendicular to the axis of the MCPCB plate, the said MCPCB plate is attached to the first heat sink
a light guide connects the MCPCB plate at one end and the second heat sink at the other end, the said light guide propagates the light through the edge-lit LED tube;
wherein the emission angle of the edge-lit tube can be controlled by controlling the etching of the surface of the light guide.

10. The edge-lit LED tube of claim 9 wherein the PCB comprises a resistor placed in series with the input port, an inductor placed in series with the cathode input, a bridge rectifier that converts the AC waveform coming from the ballast to DC waveform, a capacitor placed in parallel to the bridge rectifier and the LED.

11. The edge-lit LED tube of claim 9 wherein the heat sinks are made of aluminum or copper or thermoplastic material or a natural graphite solution.

12. The edge-lit LED tube of claim 9 wherein the LED light source comprises of a single LED or a plurality of LEDs.

13. The edge-lit LED tube of claim 9 wherein the light guide is made of material selected from optical grade material such as acrylic resin, polycarbonate, epoxies and glass.

14. The edge-lit LED tube of claim 9 wherein the light guide uses internal reflection phenomenon for propagating the light through the tube.

15. The edge-lit LED tube of claim 9 wherein the surface of the light guide is etched with a thermoplastic or an acrylic layer.

16. The edge-lit LED tube of claim 9 wherein the etching allows the light to escape from the edge-lit LED tube.

17. The edge-lit LED tube of claim 9 wherein the etching of the light guide is done to control the emission angle of light output in range of 90° to 360°.

18. The edge-lit LED tube of claim 9 wherein the LED tube is designed to fit T2, T3, T4, T5, T8, T10 or T12 type sockets.

19. The edge-lit LED tube of claim 9 wherein the edge-lit LED tube is cylindrical, circular, tubular, cubical, helical or U-shape.
